(19) United States
(12) Patent Application Publication
(10) Pub. No.: US 2013/0324932 A1
(43) Pub. Date: Dec. 5, 2013

(54) Pre-Filled Safety Applicator for Otic Medication

(71) Applicant: Thomas Paul Cogley, Pinellas Park, FL (US)

(72) Inventor: Thomas Paul Cogley, Pinellas Park, FL (US)

(73) Assignee: Thomas Paul Cogley, Pinellas Park, FL (US)

(21) Appl. No.: 13/483,793

(22) Filed: May 30, 2012

(51) Int. Cl. A61D 7/00

(52) U.S. Cl. CPC A61D 7/00
USPC 604/181; 604/275

(57) ABSTRACT

The device is essentially a pipette with pre-filled medication in it. Also, there is an additional plug with pressure release valves on the tip of the pipette.

The pre-filled medication prevents licensed practitioners from having to count drops and having to fill the pipette up, thus saving time.

The plug on the tip fits snuggly into the ear canal helping the practitioner find the perfect spot in the ear canal. Pressure relief valves in the plug helps relieve pressure in the ear canal when delivering treatment, helping for a safer treatment.

The plug on the tip of the pipette also has openings on the side to deliver treatment thus coving a wider spectrum of the ear canal, and creating a more beneficial treatment.

### BACKGROUND OF THE INVENTION

This invention is particularly suitable for veterinary medicine and the allied health sciences. In these fields some of the animals that need ear medication may be hard to handle. In addition the depth of anatomy of the ear makes it difficult for the caregiver to administer and provide the correct amount of medication. Very often, treatment of ear infections in the animal requires placement of medication directly into the ear canal. The ear canal opening unlike that in man is deep in the ear at the bottom and surrounded by several ridges. The caregiver cannot adequately determine the drops of medication into the ear and often does not know if they are at the opening of the ear. This results in inadequate treatment. The medication may be delivered in excess to the animal or below what's needed. Medication may be placed on blind spots in the ear and never reach the auditory canal. Caregivers have had to live with this problem and even often required to repeat treatment.

An applicator was needed that would provide a means to deliver the correct amount without counting drops; would fit into the area above the auditory canal snugly away from the ridges; allow the applicator to be at the opening of the ear canal but not pass deeply into it to protect the ear drum. Deliver its medication load without increasing the pressure in the auditory canal by having channels bored through the plug. The inventor, himself after seeing the present problem of medicating the ears of animals has decided to end his frustration and decided to take the time to design an applicator to help remedy the situation and this obvious handicap.

### SUMMARY OF THE INVENTION

The invention utilizes a pipette with a pre-loaded and pre-determined amount of medication that is delivered with a simple squeeze. The invention also contains a plug on the end of the pipette that will fit most all dog and cat ears. This is possible because of its cone shape. Within the plug are channels to prevent buildup of pressure in the auditory canal between the plug and the ear drum that might occur when the medication is pushed into the auditory canal from the pipette.

### BRIEF DESCRIPTION OF THE DRAWINGS

FIG. 1 is the pre-filled applicator is in contact with the dog ear. The back end of the pipette is being squeezed which is releasing the pre-filled medication into the ear canal without applying pressure.

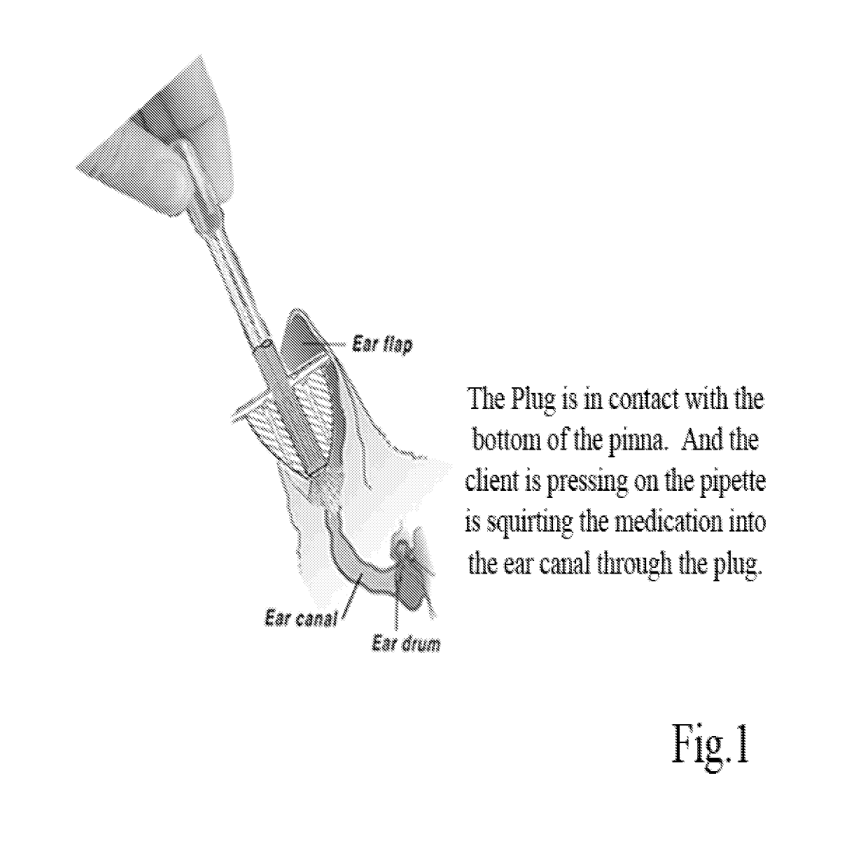

FIG. 2 is a diagram of the pre-filled applicator broken down into all of its parts. It explains how the channels inside the plug minimize the pressure in the auditory canal. How, the perforated plug provides occlusion of the auditory canal while it allows the pipette to transfer its medication. Explains how the medication is already in the pipette. Also, explains how the treatment is dispersed straight but also through side openings to create a more efficient treatment.

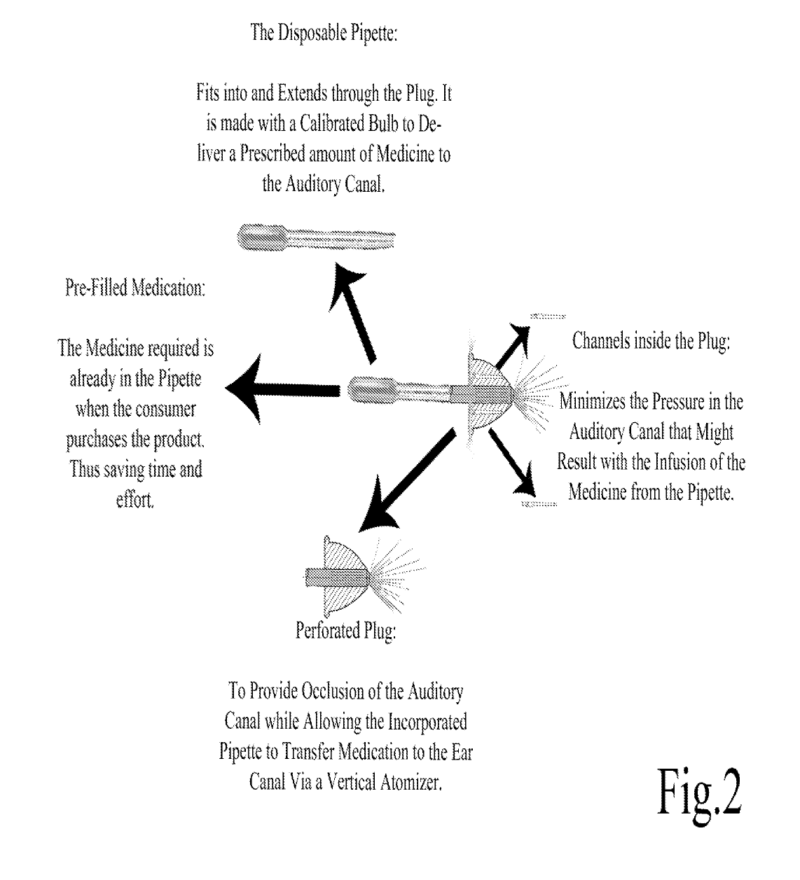

### REFERENCES CITED

U.S. Patent Documents

| | | |
|---|---|---|
| 8,162,906 | April 2012 | Terrill |
| 6,758,338 | July 2004 | Lien |
| 6,477,901 | November 2002 | Tadigadapa |

What the invention claimed is:

1. A pipette with pre-filled medication in it, at a pre-determined dosage.

2. An invention as in claim 1 however there is a plug that pops on at the end that fits directly into the ear canal, and sprays the medication directly in.

3. A similar pipette as in claim 2 however the plug also has openings on the sides which spray the medication covering a wider range with a more beneficial treatment.

4. A similar pipette as in claim 2 however the plug at the end of the pipette screws on.

5. A similar pipette as in claim 2 however the plug at the end of the pipette is already permanently molded on.

6. A similar pipette as in claim 2-5 however the plug at the end has pressure relief valves in it.

7. A similar pipette as in claim 2-6 however when the pipette is squeezed the medication flows out in a stream.

8. A similar pipette as in claim 2-6 however when the pipette is squeezed the medication flows out in a mist.
